(19) United States
(12) Patent Application Publication
(10) Pub. No.: US 2007/0052344 A1
(43) Pub. Date: Mar. 8, 2007

(54) Flat panel display device and method of correcting bonding misalignment of driver IC and flat panel display

(76) Inventors: Yu-Liang Wen, Taipei City (TW); Chin-Chung Tu, Miaoli City (TW); Zheng-Jie Huang, Taoyuan City (TW); Huang-Chang Wang, Gueishan Township (TW)

Correspondence Address: J C PATENTS, INC., 4 VENTURE, SUITE 250, IRVINE, CA, 92618, US

(21) Appl. No.: 11/221,488

(22) Filed: Sep. 7, 2005

(51) Int. Cl. H01J 1/62; H01J 63/04

(52) U.S. Cl. 313/498

(57) ABSTRACT

A method of correcting bonding misalignment between flat display panel and driver IC is provided. First, the contact pads of the bonding flat display panel and the bumps of the driver IC are bonded, wherein the flat display panel further includes a plurality of alignment marks around each contact pad. A bonding misalignment variation between the flat display panel and the driver IC may be identified by matching the position of the alignment mark and the position of the corresponding bump. Thereafter, a correction may be performed according to the bonding misalignment variation.

### BACKGROUND OF THE INVENTION

1. Field of the Invention

The present invention relates to a method of correcting bonding misalignment of a flat panel display (FPD). More particularly, the present invention relates to a method of correcting bonding misalignment between a flat panel display (FPD) or a flat display panel and a driver IC.

2. Description of Related Art

Conventionally, liquid crystal display (LCD) panel has been broadly applied for a variety of consumer electronics or computer products since the LCD panel has the advantages of light weight, thin thickness, small size, low driving voltage, low power consumption and broad application, especially for the notebook or portable computer.

In recent years, the chip on glass (COG) method has been developed for the bonding of the driver ICs to the display panel. Therefore, the thickness of the LCD panel is reduced and the reliability thereof is increased. The chip on glass (COG) method is performed by using a thermal pressing process to bond the driver ICs (i.e., the gate driver IC or the source driver IC) directly on the glass substrate, instead of the conventional tape carrier package (TCP) or chip on film (COF) package method. Therefore, since the circuit board used in the conventional tape carrier package (TCP) is omitted in the chip on glass (COG) method, the display panel bonded by the chip on glass (COG) method is thinner and lighter. In addition, the cost of the display panel is also reduced. Moreover, the chip on glass (COG) bonding method has a better humidity and vibration reliability for the display panel compared to the conventional tape carrier package (TCP) adhesion method. Hereinafter, a brief description will be made referring to FIG. 1A, FIG. 1B and FIG. 2.

FIG. 1A is a schematic top view of a conventional driver IC. FIG. 1B is a schematic lateral view of a conventional driver IC. Referring to FIG. 1A and FIG. 1B, a driver IC 100 and bumps 110 for connecting electrical signal is illustrated.

FIG. 2 is a schematic cross-sectional view illustrating a correct bonding between the bumps shown in FIG. 1B and the contact pads on the glass substrate. Referring to FIG. 2, the chip on glass (COG) bonding method is performed by the following steps. First, the bumps 110 are aligned to the contact pads 210 on the glass substrate 200. Thereafter, the driver IC 100 and the glass substrate 200 are bonded with each other by using a thermal pressing process via anisotropic conductive film (ACF) 220.

In general, the size of the bumps 110 described above is about several tenth of μm², and the interval between two bumps 110 is less than about 100 μm. However, the size and the interval of the bumps 110 are gradually reduced due to increase in the resolution of the panel. Therefore, the yield after the thermal pressing process is reduced, and thus the cost of the LCD panel is increased.

FIG. 3 is a schematic cross-sectional view illustrating a misalignment of bonding between the bumps 110 and the contact pads 210 on the glass substrate 200 shown in FIG. 1B. Referring to FIG. 3, the misalignment bonding may be produced by, for example, the misalignment of the precision of the equipment (e.g., especially the thermal pressing head) in the thermal pressing process. Therefore, the display quality of the LCD panel is worse due to the influence of the unexpected impedance to the electrical signal transmission caused due to the bonding misalignment. In addition, when the bonding fails, the bumps 110 of the driver IC are deformed. Therefore, if the driver IC is pulled out for re-bonding, the contact between the bumps 110 and the contact pads 210 would be worse, consequently, the signals will be shorted. Therefore, it is not practical to rework the failed bonded display panel. Especially, in the manufacturing process of the liquid crystal display panel, the bonding process is performed near the end of the whole process. Therefore, the cost of the LCD panel is highly dependent on the yield of the thermal pressing process of the chip on glass (COG) bonding method.

### SUMMARY OF THE INVENTION

Therefore, the present invention is directed to a flat panel display comprising a specific layout of alignment mark for identifying the misalignment of the bonding between a flat display panel and a driver IC.

The present invention is also directed to a method of correcting bonding misalignment of a flat display panel and driver IC after the misalignment of the bonding between bumps and alignment mark is being identified to increase the yield of the thermal pressing process of the chip on glass (COG) method and to improve the display quality.

In accordance with one embodiment of the present invention, a flat panel display comprising a flat display panel, at least a driver IC and a plurality of alignment marks is provided. The flat display panel comprises a plurality of contact pads. The driver IC comprises a plurality of bumps, and the driver IC is adhered to the flat display panel, thus the contact pads of the flat display panel and the bumps of the driver IC are electrically connected. Each alignment mark is disposed around each contact pad.

In accordance with one embodiment of the present invention, a method of correcting bonding misalignment between a flat display panel and driver IC is also provided. First, the contact pads of the flat display panel and the bumps of the driver IC are bonded, wherein the flat display panel further comprises a plurality of alignment marks around each contact pad. Thereafter, the alignment mark and the bump are matched to measure a bonding misalignment variation between the liquid crystal display panel and the driver IC. Then a correction is performed according to the bonding misalignment variation.

Accordingly, in the present invention, since a layout of the alignment mark is disposed around the pattern of the substrate, therefore the misalignment of the bonding between the driver IC and the liquid crystal display panel can be measured. Therefore, in the preceeding process, when the bonding of the driver IC and the liquid crystal display panel is performed, the identification of misalignment may be performed to optimize and correct the process tool and apparatus to avoid the failure of the bonding and to increase the yield.

One or part or all of these and other features and advantages of the present invention will become readily apparent to those skilled in this art from the following description wherein there is shown and described one embodiment of this invention, simply by way of illustration of one of the modes best suited to carry out the invention. As it will be realized, the invention is capable of different embodiments, and its several details are capable of modifications in various, obvious aspects all without departing from the invention. Accordingly, the drawings and descriptions will be regarded as illustrative in nature and not as restrictive.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a schematic top view of a conventional driver IC.

FIG. 1B is a schematic lateral view of a conventional driver IC.

FIG. 2 is a schematic cross-sectional view illustrating a correct bonding between the bumps shown in FIG. 1B and the contact pads on the glass substrate.

FIG. 3 is a schematic cross-sectional view illustrating a misalignment bonding between the bumps and the contact pads on the glass substrate shown in FIG. 1B.

FIG. 4A and is a schematic top view of a flat display panel according to one embodiment of the present invention.

FIG. 4B is a schematic lateral view of a flat display panel according to one embodiment of the present invention.

FIG. 5 is a schematic local cross-sectional view of a flat panel display (FPD) according to one embodiment of the present invention.

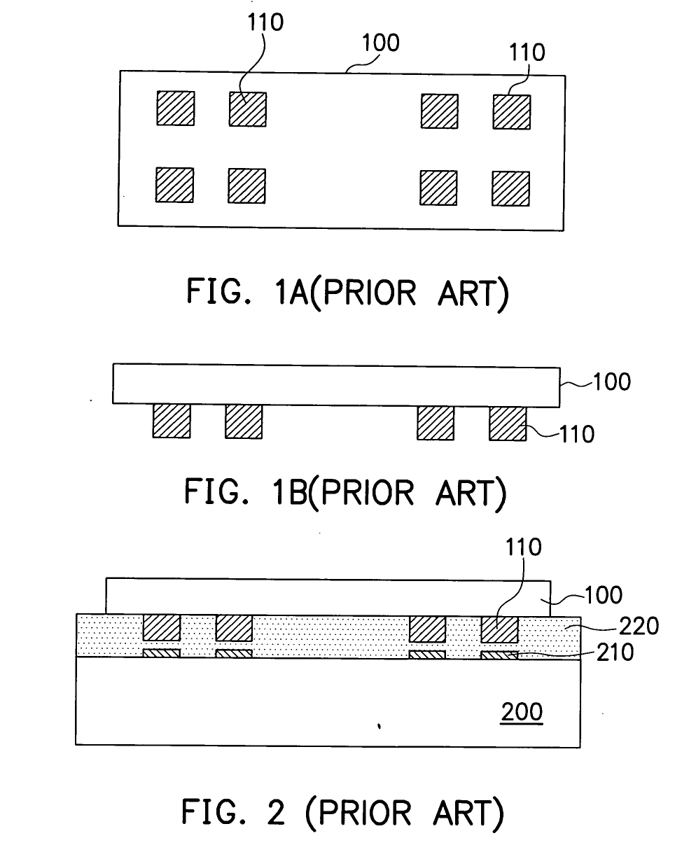

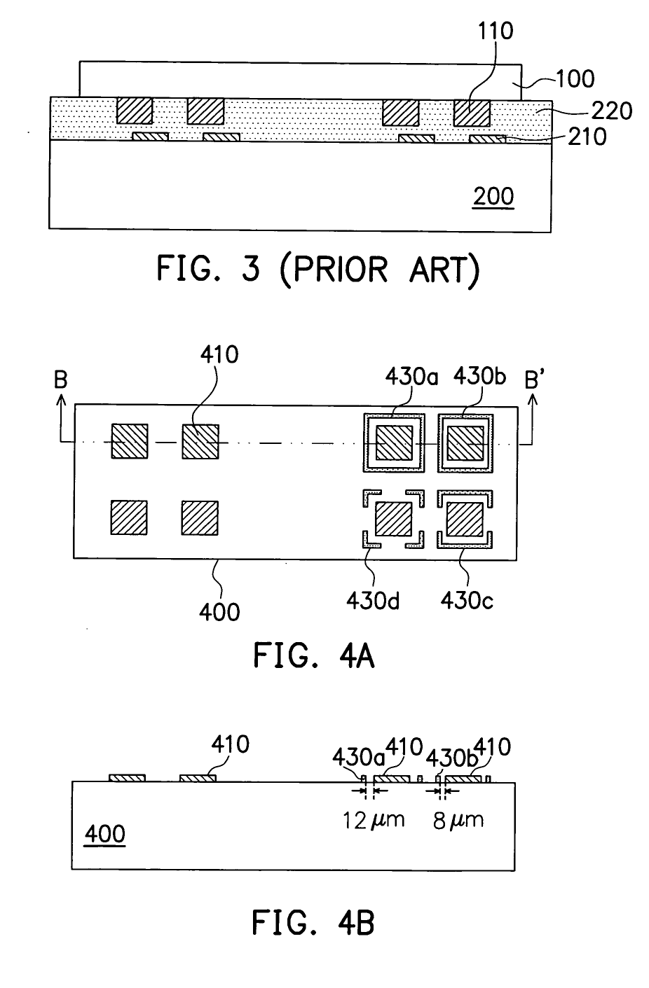

### DESCRIPTION OF THE EMBODIMENTS

The present invention now will be described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

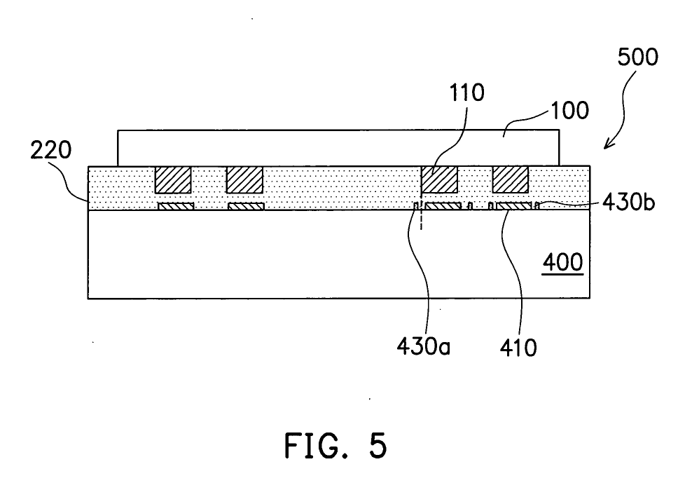

FIG. 5 is a schematic local cross-sectional view of a flat panel display (FPD) according to one embodiment of the present invention. FIG. 4A is a schematic local schematic top view of a flat display panel according to one embodiment of the present invention. It is noted that, the components, which are well known to those skilled in the art are omitted in these drawings. FIG. 4B is a schematic cross-sectional view along line B-B′ of FIG. 4A. Referring to FIG. 5, FIG. 4A and FIG. 4B, the a flat panel display 500 comprises a flat display panel 400, at least a driver IC 100 and a plurality of alignment marks 430a, 430b, 430c and 430d.

In one embodiment of the present invention, the flat display panel 400 comprises, for example but not limited to, a liquid crystal display panel, an active organic electro-luminescent panel or other flat display panel. The flat display panel 400 comprises, for example, a plurality of contact pads 410 for electrically connecting the components (pixel units) in the flat display panel 400 to the external circuit.

The driver IC 100 comprises a plurality of bumps 110. The bumps 110 can be gold bumps, for example, but not limited to. The driver IC 100 is adhered to the flat display panel 400, and thus the contact pads 410 of the flat display panel 400 and bumps 110 of the driver IC 100 are electrically connected via the anisotropic conductive film (ACF) 220.

Moreover, each of the alignment marks 430a to 430d (as illustrated in FIG. 4A and FIG. 4B) is disposed over the flat display panel 400, and around each contact pad 410 for correction. In addition, the alignment marks 430a to 430d may be in a several kind of shapes, for example but not limited to, a annular structure (such as the alignment marks 430a and 430b), a [shape structure and a] shape structure (such as the alignment mark 430c), or four L shape structures at four corners of each of the contact pads respectively (such as the alignment mark 430d). The alignment marks of the flat display panel 400 may comprise only one single shape structure of alignment mark, or a combination of several kinds of shape structures. The alignment marks 430a to 430d may also be disposed around dummy pads, or may be disposed around real contact pads. In addition, a material of the alignment marks 430a to 430d comprises, for example but not limited to, a conductor or an insulator. When the material of the alignment marks 430a to 430d is a conductor, it is preferable to dispose the alignment marks 430a to 430d around the dummy pads.

Referring to FIG. 4A and FIG. 4B, each of the intervals between the alignment marks 430a to 430d and the corresponding contact pads 410 may be same or different. For example, as shown in FIG. 4B, the intervals between the alignment marks 430a/430b and the corresponding contact pads 410 are about 12 μm and 8 μm respectively. It is noted that, the misalignment may be measured by the variation of the intervals. In other words, the misalignment may be decided by using a variety of different intervals between the alignment mark and the corresponding contact pad is preset. Moreover, the line width between the alignment marks 430a to 430d may also be changed according to the requirement of the process, and should not be limited to the drawings illustrated in the present invention.

FIG. 5 is a schematic cross-sectional view illustrating a bonding misalignment between a flat display panel 400 and a driver IC shown in FIG. 4B. Referring to FIG. 5, in a chip on glass (COG) bonding method, first of all, the contact pads 410 of the flat display panel 400 is aligned to the bumps 110 of the driver IC 100. Then, a thermal pressing process is performed to bind the driver IC 100 and the liquid crystal display panel 400 with each other via an anisotropic conductive film (ACF) 220. When a misalignment between the flat display panel 400 and the driver IC 100 is produced due to, for example but not limited to, a precision of the equipment (especially thermal pressing head) of the thermal pressing process, a bonding misalignment variation between the flat display panel 400 and the driver IC 100 may be determined by matching the position of the alignment marks 430a or 430b with the bumps 110. For example, as shown in FIG. 5, the bumps 110 of the driver IC 100 are overlapped with the alignment mark 430b, but not overlapped with the alignment mark 430a. Therefore, the misalignment of the bonding is between about 8 μm to about 12 μm. Therefore, in the proceeding process, the parameters of the process tool or apparatus may be optimized according to the bonding misalignment variation to avoid the failure of the bonding and to increase the yield.

In addition, the alignment marks 430a to 430d may be disposed around some of the specific contact pads 410, or around any dummy pads. It is noted that there are no signal transmitted by the dummy pad. Therefore, if the alignment marks 430a to 430d, the bumps 110 and the dummy pad are electrically connected due to the misalignment, the normal signal transmission will not be influenced. Alternatively, the alignment marks 430a to 430d may also be disposed around the patterns of the flat display panel 400 and should not be limited to the position illustrated in the embodiments of the present invention.

Accordingly, in the present invention, since a layout of the alignment mark is disposed around the pattern of the substrate, therefore the misalignment of the bonding between the driver IC and the liquid crystal display panel can be measured. Therefore, when the bonding of the driver IC and the liquid crystal display panel is performed, the identification of misalignment may be performed to optimize and correct the process tool and apparatus to avoid the failure of the bonding and to increase the yield.

The foregoing description of the embodiment of the present invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A flat panel display (FPD), comprising:
a flat display panel, comprising a plurality of contact pads; and
at least a driver IC, comprising a plurality of bumps, wherein the driver IC is adhered to the flat display panel and the contact pads of the flat display panel are electrically connected to the bumps of the driver IC; and
a plurality of alignment marks, each of the alignment marks disposed around each of the contact pads.

2. The FPD of claim 1, wherein each of the alignment marks comprises an annular structure.

3. The FPD of claim 1, wherein each of the alignment marks comprises a shape structure.

4. The FPD of claim 1, wherein each of the alignment marks comprises four L shape structures at four corners of each of the contact pads respectively.

5. The FPD of claim 1, wherein each of the alignment marks comprises a conductor or an insulator.

6. The FPD of claim 1, wherein an interval between the alignment marks and the contact pads is correspondingly same.

7. The FPD of claim 1, wherein an interval between the alignment marks and the contact pads is correspondingly different.

8. The FPD of claim 1, wherein the flat display panel comprises a liquid crystal display panel or an active organic electro-luminescent display panel.

9. The FPD of claim 1, further comprises an anisotropic conductive film disposed between the contact pads of the flat display panel and the bumps of the driver IC.

10. A method of correcting a bonding misalignment between a flat display panel and a driver IC, comprising:
bonding a plurality of contact pads of a flat display panel to a plurality of bumps of a driver IC, wherein the flat display panel comprises a plurality of alignment marks around each of the contact pads;
matching the alignment marks and the bumps to identify a bonding misalignment variation between the flat display panel and the driver IC; and
performing a correction according to the bonding misalignment variation.

11. The correction method of claim 10, wherein each of the alignment marks comprises an annular structure.

12. The correction method of claim 10, wherein each of the alignment marks comprises a shape structure.

13. The correction method of claim 10, wherein each of the alignment marks comprises four L shape structures at four corners of each of the contact pads respectively.

14. The correction method of claim 10, wherein each of the alignment marks comprises a conductor or an insulator.

15. The correction method of claim 10, wherein an interval between the alignment marks and the contact pads is correspondingly same.

16. The correction method of claim 10, wherein an interval between the alignment marks and the contact pads is correspondingly different.

17. The correction method of claim 10, wherein a step of bonding the contact pads of the flat display panel and the bumps of the driver IC, comprises:
aligning the contact pads of the flat display panel to the bumps of the driver IC; and
performing a thermal pressing process to bind the driver IC and the flat display panel with each other via an anisotropic conductive film.

18. The correction method of claim 10, wherein the flat display panel comprises a liquid crystal display panel or an active organic electro-luminescent display panel.
